(19) United States
(12) Patent Application Publication
(10) Pub. No.: US 2011/0089899 A1
(43) Pub. Date: Apr. 21, 2011

(54) Lithium-ion auto startup storage battery with a supercapacitor function

(76) Inventors: Xin Xu, Beijing (CN); Fang Ai, Beijing (CN)

(21) Appl. No.: 12/582,685

(22) Filed: Oct. 20, 2009

(51) Int. Cl. H02J 7/04; H02J 7/00

(52) U.S. Cl. 320/118; 320/134

(57) ABSTRACT

A lithium-ion auto startup storage battery with a supercapacitor function, includes a power supply, composed of a plurality of lithium batteries connected with each other in series; a supercapacitor connected with the power supply in parallel; an over charge-discharge protection device connected with the power supply in parallel; and a double-loop charge-protection system connected with the supercapacitor in parallel, which includes an inner loop circuit and an outer loop circuit, so that a constant current charger achieves firstly a constant current and then a constant voltage when the lithium-ion battery is charged. The present invention further includes a digital control voltage feedback multilevel current device to resolve an equilibrium problem of connecting large-capacity lithium-ion batteries in series. The present invention further includes a bidirectional current automatic converter to make a standard two-wire battery charge and discharge system of automobile achieve a three-wire system function of lithium-ion battery.

### BACKGROUND OF THE PRESENT INVENTION

1. Field of Invention

The present invention relates to a lithium-ion auto startup storage battery, and more particularly to a lithium-ion auto startup storage battery with a supercapacitor function.

2. Description of Related Arts

Traditional auto startup storage battery is made of lead-acid material, so it is easy to greatly pollute the environment during production, scrap disposal and recycling process. In addition, a voltage of the lead-acid battery will be reduced with the decrease of the electric capacity, the ignition system of an automobile can not always maintain a stable voltage, thereby increasing fuel consumption. The lithium-ion battery, instead of the traditional lead-acid battery, in the auto startup system has the following advantages. Firstly, all materials of the lithium-ion auto startup storage battery are non-toxic and nonpolluting. Besides recycling and reusing of some materials of the housing, the main raw materials of the content, such as manganese, phosphorus, iron, are major components of plant fertilizer, thus avoiding the environment pollution. Secondly, compared with lead-acid batteries, the voltage of lithium-ion battery is very stable, so the ignition system of automobile can always maintain a stable voltage. That is to say, the spark plug ignition has maintained the best condition, so it can save fuel of 10%-25% or more, and make the automobile stronger. Thirdly, the lithium-ion auto startup battery is not easy to start aging, and has a long service life. After 3000 times of repeating charge-discharge, the decay rate of electric capacity is generally only about 15%. In other words, the lithium-ion auto startup battery can be used more than 10 years under normal environment and use. Fourthly, the lithium-ion battery has a small size and light weight.

In spite that the lithium-ion auto startup storage battery has so many advantages, it does not currently capable of being widely used due to some technical problems. These technical problems include:
1. The lithium-ion battery can't be full if the existing car charger directly charges, conventional implementation requires to adjust the entire electronic systems of automobile.
2. A plurality of lithium-ion batteries are connected in series to satisfy the auto startup voltage of about 12V, however, the equilibrium problem of connecting large-capacity lithium-ion batteries in series, has not yet been properly resolved.
3. In order to prevent high-current charging and discharging of the lithium-ion batteries from damaging the life of electronic components, high-power lithium-ion batteries generally use the three-wire system to separate the charging power supply and load negative wire. However, the existing automobile charger uses a two-wire-connection (i.e., charging power supply and load use a same negative line and positive line), so two kinds of wire connection manner can not be compatible with each other.
4. The lithium-ion battery can't be full while being charged at lower temperature.
5. The auto startup storage battery needs a greater current (typically about 300 A) in a shorter time to start the automobile, it is very difficult for the lithium-ion battery with conventional capacity (especially at the low-temperature condition) to provide the greater current.

### SUMMARY OF THE PRESENT INVENTION

An object of the present invention is to provide a lithium-ion auto startup storage battery with a supercapacitor function, which is capable of replacing a traditional lead-acid auto startup storage battery without any adjustment of an electronic system of automobile.

Another object of the present invention is to provide a lithium-ion auto startup storage battery with a supercapacitor function, which comprises a double-loop charge-protection system so that a constant current charger achieves firstly a constant current and then a constant voltage when the lithium-ion battery is charged.

Another object of the present invention is to provide a lithium-ion auto startup storage battery with a supercapacitor function, which comprises a digital control voltage feedback multilevel current device to resolve an equilibrium problem of connecting large-capacity lithium-ion batteries in series.

Another object of the present invention is to provide a lithium-ion auto startup storage battery with a supercapacitor function, which comprises a bidirectional current automatic converter to make a standard two-wire battery charge and discharge system of automobile achieve a three-wire system function of lithium-ion battery.

Another object of the present invention is to provide a lithium-ion auto startup storage battery with a supercapacitor function, which can be full while being charged at lower temperature.

Another object of the present invention is to provide a lithium-ion auto startup storage battery with a supercapacitor function, which has a dual insurance structure to make the lithium-ion battery with an excellent start-up performance.

Accordingly, in order to accomplish the above object, the present invention provides a lithium-ion auto startup storage battery with a supercapacitor function, comprising:

a power supply, composed of a plurality of lithium batteries connected with each other in series;

a supercapacitor connected with the power supply in parallel;

an over charge-discharge protection device connected with the power supply in parallel; and

a double-loop charge-protection system connected with the supercapacitor in parallel, comprising:
an inner loop circuit comprising a voltage clamping current shunting circuit and a temperature comparing circuit connected with the voltage clamping current shunting circuit,
   wherein the voltage clamping current shunting circuit comprises a voltage reference, a first comparator, a first resistance, a first switch, a second resistance, a second switch, and a current shunting control module, wherein the first resistance is connected with the first switch in series for forming a first voltage clamping shunt branch, the second resistance is connected with the second switch in series for forming a second voltage clamping shunt branch, after connecting the first voltage clamping shunt branch with second voltage clamping shunt branch in parallel, one end of which is connected with an anode of the power supply, another end of which is connected with a cathode of the power supply by the current shunting control module, the anode of the power supply is connected with an in-phase input of the first comparator, the cathode of the power supply is connected with an inverted input of the first comparator, the output of the first comparator is connected with the current shunting control module, in such a manner that, the first voltage clamping shunt branch, current shunting control module, first comparator, voltage reference, power supply form a first voltage clamping shunt circuit, the second voltage clamping shunt branch, current shunting control module, first comparator, voltage reference, power supply form a second voltage clamping shunt circuit;
   wherein the temperature comparing circuit of the inner loop circuit comprises a first hysteresis comparator, a NOT gate, and a second hysteresis comparator, wherein an in-phase input of the first hysteresis comparator inputs a temperature of the first voltage clamping shunt circuit, an inverted input of the first hysteresis comparator inputs a first or second temperature threshold, an output of the first hysteresis comparator is connected with an input of the NOT gate, an output of the NOT gate is connected with the first switch K1 to control the closure of the first switch at high level, an in-phase input of the second hysteresis comparator inputs a temperature of the second voltage clamping shunt circuit, an inverted input of the second hysteresis comparator inputs the first or second temperature threshold, an output of the first hysteresis comparator is connected with the second switch to control the closure of the second switch at high level; and

an outer loop circuit, comprising a suspension charging module and AND gate, wherein the output of the first hysteresis comparator and the output of the second hysteresis comparator are two inputs of the AND gate, respectively, an output of the AND gate is connected with the suspension charging module.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a lithium-ion auto startup storage battery with a supercapacitor function according to a first preferred embodiment of the present invention.

FIG. 2 is a circuit diagram of a double-loop charge-protection system according to the above first preferred embodiment of the present invention.

FIG. 3 is a circuit diagram of a clamp current voltage-divided circuit as shown in FIG. 2.

FIG. 4 is a circuit diagram of a first alternative mode of a clamp current voltage-divided circuit as shown in FIG. 2.

FIG. 5 is a circuit diagram of a second alternative mode of a clamp current voltage-divided circuit as shown in FIG. 2.

FIG. 6 is schematic view of a lithium-ion auto startup storage battery with a supercapacitor function according to a second preferred embodiment of the present invention.

FIG. 7 is circuit diagram of a digital control voltage feedback multilevel current device according to the above second preferred embodiment of the present invention.

FIG. 8 is a schematic view of a lithium-ion auto startup storage battery with a supercapacitor function according to a third preferred embodiment of the present invention.

FIG. 9 is a circuit diagram of a bidirectional current automatic converter according to the above third preferred embodiment of the present invention.

FIG. 10 is a circuit diagram of the bidirectional current automatic converter according to an alternative mode of the above third preferred embodiment of the present invention.

FIG. 11 is a schematic view of a lithium-ion auto startup storage battery with a supercapacitor function according to a fourth preferred embodiment of the present invention.

### DETAILED DESCRIPTION OF THE PREFERRED EMBODIMENT

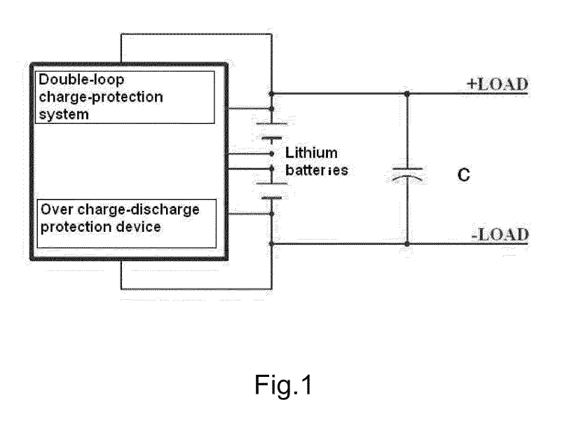

Referring to FIG. 1 of the drawings, a lithium-ion auto startup storage battery with a supercapacitor function according to a first preferred embodiment of the present invention is illustrated, in which the lithium-ion auto startup storage battery with a supercapacitor function comprises a power supply, composed of a plurality of lithium batteries connected with each other in series, a supercapacitor connected with the power supply in parallel, an over charge-discharge protection device connected with the power supply in parallel, and a double-loop charge-protection system connected with the supercapacitor in parallel.

The supercapacitor can be used to start the lithium-ion auto startup storage battery for achieving the high current what are needed when the auto startup battery ignites (especially at low temperature). On the one hand, the lithium batteries are adapted for “charging” the supercapacitor, on the other hand, the lithium batteries are capable of providing the follow-up current when the supercapacitor insufficiently provides the current. The double-insurance structure, as mentioned above, makes the lithium-ion auto startup storage battery with an excellent start-up performance.

The over charge-discharge protection device is capable of preventing the over charge, over-discharge, over-temperature, over-current of the lithium batteries, and so on.

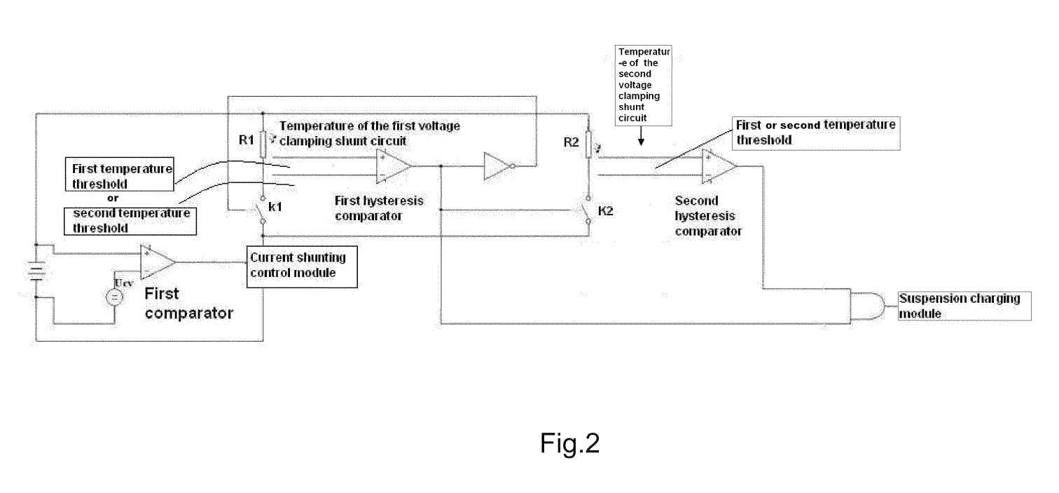

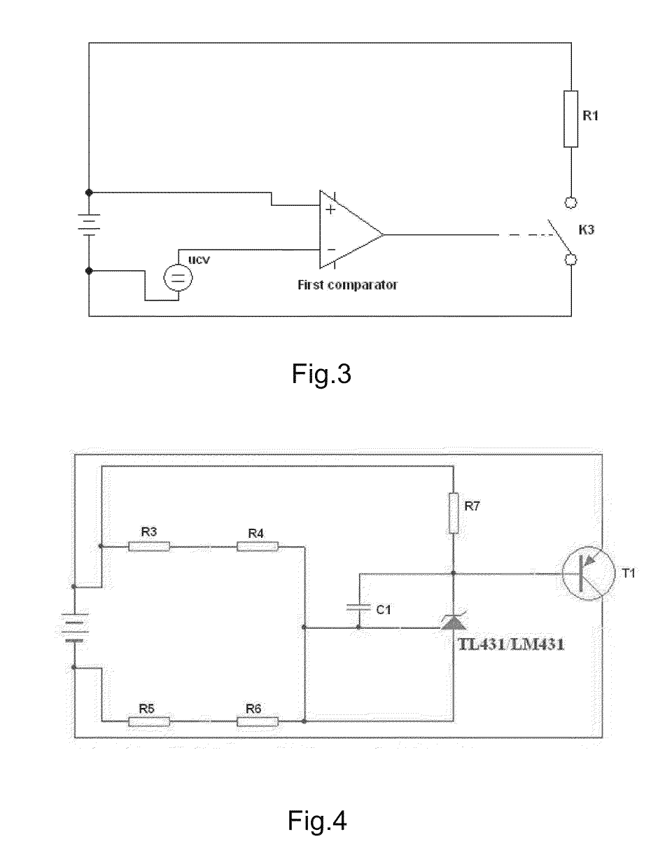

As shown in FIG. 2, the double-loop charge-discharge protection system for controlling the charge process, which comprises an inner loop circuit and an outer loop circuit. The inner loop circuit comprises a voltage clamping current shunting circuit, and a temperature comparing circuit connected with the voltage clamping current shunting circuit. The voltage clamping current shunting circuit comprises a voltage reference Ucv, a first comparator, a first resistance R1, a first switch K1, a second resistance R2, a second switch K2, and a current shunting control module, wherein, the first resistance R1 is connected with the first switch K1 in series for forming a first voltage clamping shunt branch L1, the second resistance R2 is connected with the second switch K2 in series for forming a second voltage clamping shunt branch L2. After connecting the first voltage clamping shunt branch L1 with second voltage clamping shunt branch L2 in parallel, one end of which is connected with an anode of the power supply, another end of which is connected with a cathode of the power supply by the current shunting control module. Furthermore, the anode of the power supply is connected with an in-phase input of the first comparator (namely “+” terminal), the cathode of the power supply is connected with an inverted input of the first comparator (namely “−” terminal), the output of the first comparator is connected with the current shunting control module. Accordingly, the first voltage clamping shunt branch L1, current shunting control module, first comparator, voltage reference Ucv, power supply form a first voltage clamping shunt circuit, similarly, the second voltage clamping shunt branch L2, current shunting control module, first comparator, voltage reference Ucv, power supply form a second voltage clamping shunt circuit. It is worth to mention that the current shunting control module is a third switch K3 in FIG. 3, which is closed at high level.

The operating principle of the first and second voltage clamping shunt circuit is explained as follows. When a voltage of the power supply is larger than that of the voltage reference Ucv, the first comparator is reversed, so that the current shunting control module is closed to shunt a part of current from the voltage reference Ucv. At this time, under the influence of an internal resistance of the power supply, a voltage of the power supply after being shunted is decreased, thus forming a whole negative feedback process. A result of the negative feedback process is that the voltage of power supply will be stabilized at constant pressure point if a shunt current resistance is small enough, excess current of the voltage reference Ucv will be transformed to bypass heat so that a constant current charger achieves the first constant current and then constant pressure.

Furthermore, the temperature comparing circuit of the inner loop circuit comprises a first hysteresis comparator, a NOT gate, and a second hysteresis comparator, wherein, an in-phase input of the first hysteresis comparator inputs a temperature of the first voltage clamping shunt circuit, an inverted input of the first hysteresis comparator inputs a first or second temperature threshold, an output of the first hysteresis comparator is connected with an input of the NOT gate, an output of the NOT gate is connected with the first switch K1 to control the closure of the first switch K1 at high level. Similarly, an in-phase input of the second hysteresis comparator inputs a temperature of the second voltage clamping shunt circuit, an inverted input of the second hysteresis comparator inputs the first or second temperature threshold, an output of the first hysteresis comparator is connected with the second switch K2 to control the closure of the second switch K2 at high level.

The outer loop circuit comprises a suspension charging module and AND gate, wherein the output of the first hysteresis comparator and the output of the second hysteresis comparator are two inputs of the AND gate, respectively, an output of the AND gate is connected with the suspension charging module. It is worth to mention that the switches K1, K2 and K3 are closed at high level.

Accordingly, the operating principle of the double-loop charge-protection system is explained as follows. When one of the temperature of the first voltage clamping shunt circuit, and the temperature of the second voltage clamping shunt circuit is larger than a set value (the first temperature threshold), another voltage clamping shunt circuit is started till the temperatures of the first voltage clamping shunt circuit and the second voltage clamping shunt circuit are larger than the first temperature threshold. When the temperatures of the first voltage clamping shunt circuit and the second voltage clamping shunt circuit are larger than the first temperature threshold, the outer loop circuit will be started to suspend the charge. When a temperature of voltage clamping shunt circuit of the inner loop is lower than another set value (the second temperature threshold, wherein the second temperature threshold is lower than the first temperature threshold), the charge process is restarted till finishing charging.

According to the principle of voltage clamping shunt current, the present invention provides a cost-effective implementation plan, as shown in FIG. 4.

A first base divider resistor R3 is connected with a first adjustable resistor R4 in series to form a third branch L3, a second base resistor divider resistor R5 is connected with a second adjustable resistor R6 in series to form a fourth branch L4, an end of the third branch L3 is connected with the anode of the power supply, an end of the fourth branch L4 connected with the cathode of the power supply, after connecting another end of the third branch L3 with that of the fourth branch L4, which is connected with a reference voltage setting terminal of a three-terminal regulator TL431/LM431, an anode of the three-terminal regulator is connected with the cathode of the power supply by the fourth branch L4, an cathode of the three-terminal regulator is connected with the anode of the power supply by a third resistor R7, the reference voltage setting terminal and the cathode of the three-terminal regulator are connected with each other by a capacitor C1, the cathode of the three-terminal regulator is connected with a base of a PNP transistor T1, a collector of the PNP transistor T1 is connected with the cathode of the power supply, an emitter of the PNP transistor T1 is connected with the anode of the power supply.

Referring to FIGS. 2 to 4, the TL431/LM431 is cooperated with the divider resistors in FIG. 4 to accomplish a unit composed of the voltage reference Ucv and the first comparator in FIG. 2, the current shunting control module in FIG. 2 is accomplished by the PNP transistor T1 in FIG. 4. Furthermore, a plurality of divider resistors are connected with each other in series to adjust an error of TL431/LM431 as the voltage reference, that is to say, R3 and R5 are base divider resistors, R4 and R6 are adjustable resistors.

It is worth to mention that in order to prevent the voltage line loss caused by high-current of shunt circuit, the voltage collection point of the voltage clamping shunt circuit and the access point of the voltage clamping shunt circuit with the power supply should be separately arranged.

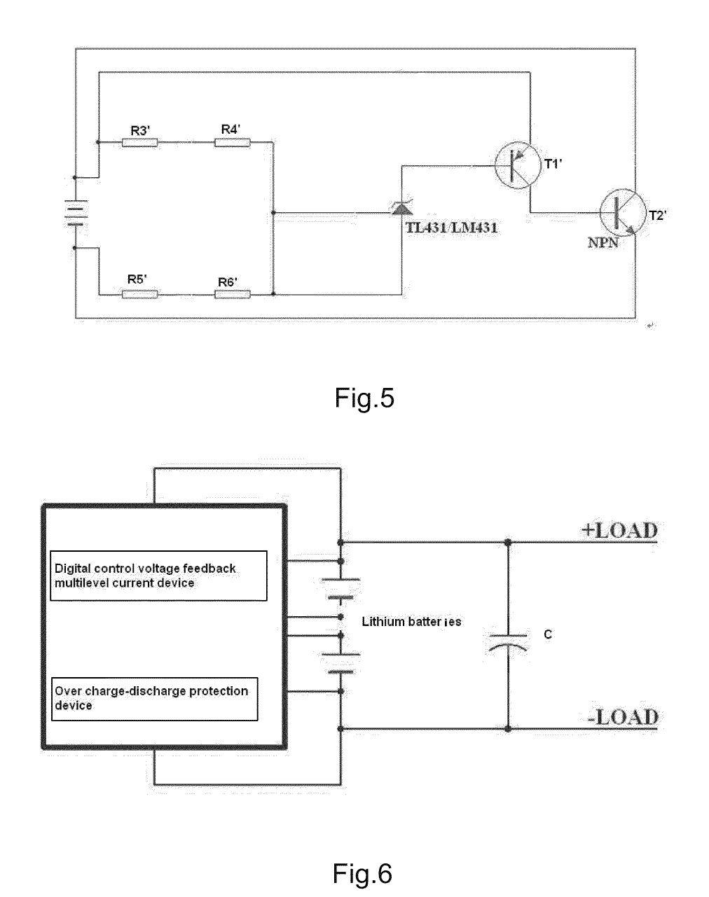

FIG. 5 is a second alternative mode of the voltage clamping shunt circuit in FIG. 2, further enhancing the ability of shunting.

A first base divider resistor R3′ is connected with a first adjustable resistor R4′ in series to form a third branch L3′, a second base resistor divider resistor R5′ is connected with a second adjustable resistor R6′ in series to form a fourth branch L4′, an end of the third branch L3′ is connected with the anode of the power supply, an end of the fourth branch L4′ connected with the cathode of the power supply, after connecting another end of the third branch L3′ with that of the fourth branch L4′, which is connected with a reference voltage setting terminal of a three-terminal regulator TL431/LM431, an anode of the three-terminal regulator is connected with the cathode of the power supply by the fourth branch L4′, an cathode of the three-terminal regulator is connected with a base of a PNP transistor T1′, an emitter of the PNP transistor T1′ is connected with the anode of the power supply, a collector of the PNP transistor T1′ is connected with a base of a NPN transistor T2′, an emitter of the NPN transistor T2′ is connected with the cathode of the power supply, a collector of the NPN transistor T2′ is connected with the anode of the power supply.

Similarly, in order to prevent the voltage line loss caused by high-current of shunt circuit, the voltage collection point of the voltage clamping shunt circuit and the access point of the voltage clamping shunt circuit with the power supply should be separately arranged.

In addition, people who skilled in the art will use MOS transistor, Darlington transistor to achieve the function of the current shunting control module.

FIG. 6 is schematic view of a lithium-ion auto startup storage battery with a supercapacitor function according to a second preferred embodiment of the present invention, which comprises a power supply, composed of a plurality of lithium batteries connected with each other in series, a supercapacitor connected with the power supply in parallel, an over charge-discharge protection device connected with the power supply in parallel, and a digital control voltage feedback multilevel current device connected with the supercapacitor in parallel.

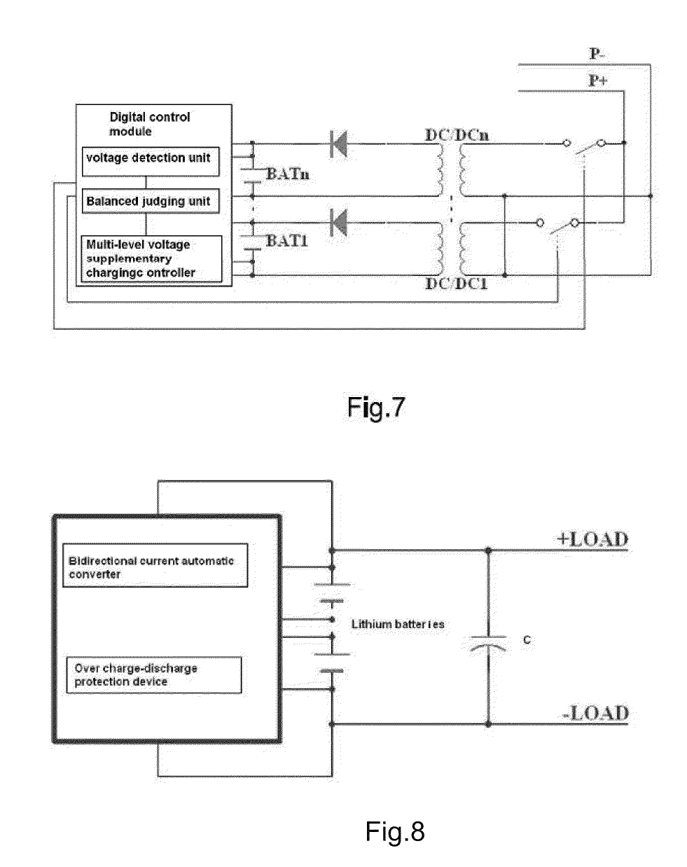

As shown in FIG. 7, the digital control voltage feedback multilevel current device comprises a digital control module and a plurality of separately charging circuits, wherein each of the separately charging circuits comprises a diode and DC-DC module power supply, that is to say, each of the lithium batteries is matched with each of the separately charging circuits (shown as DC/DC1 . . . DC/DCn), a voltage of each of the lithium batteries is drawn out of a root thereof and feeds back to the digital control module, the diode is reverse-connected, in such a manner that, when a feedback voltage of each of the lithium batteries is not balanced, the digital control module gives directions to supplementarily charge one of the lithium batteries with lower voltage by a corresponding separately charging circuit (this supplementary charging process adopt a multi-level current method, namely, it intelligently adjusts a value of supplementary current according to a voltage difference) till the voltage of each of the lithium batteries is balanced. The method resolves not only the balance problem of the large-capacity lithium-ion batteries connected in series, but also the conventional plan with big heat. The digital control module includes a voltage detection unit, a balanced judging unit connected with the voltage detection unit, and a multi-level voltage supplementary charging controller connected with the balanced judging unit.

FIG. 8 is a schematic view of a lithium-ion auto startup storage battery with a supercapacitor function according to a third preferred embodiment of the present invention, which comprises a power supply, composed of a plurality of lithium batteries connected with each other in series, a supercapacitor connected with the power supply in parallel, an over charge-discharge protection device connected with the power supply in parallel, and a bidirectional current automatic converter connected with the supercapacitor in parallel.

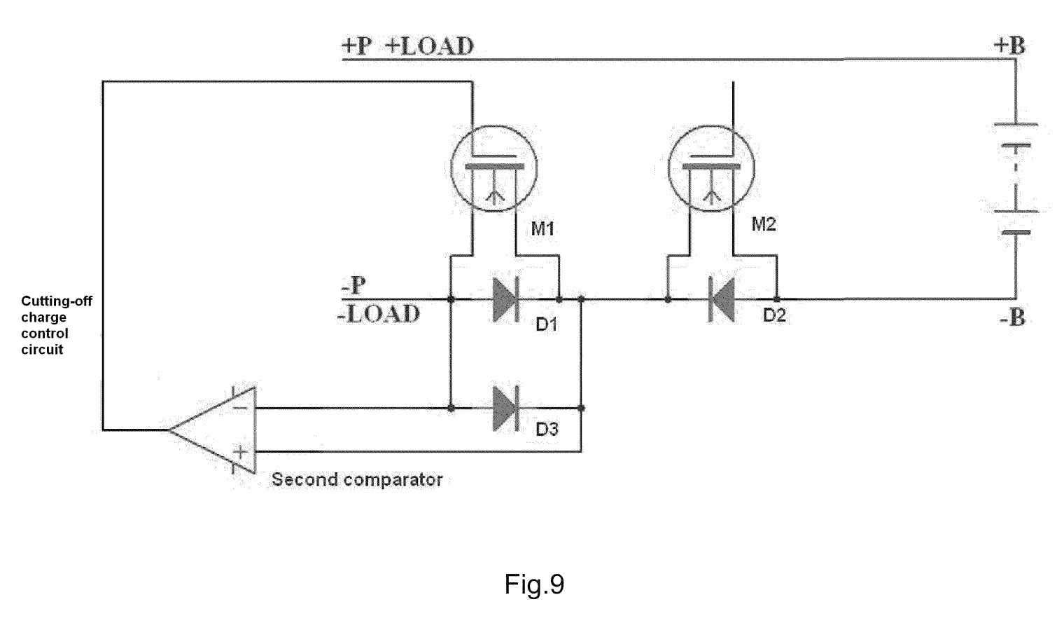

FIG. 9 is a circuit diagram of the bidirectional current automatic converter according to the above third preferred embodiment of the present invention. As shown in FIG. 9, the cathode of the power supply is connected with an anode of a second diode D2, a source and a drain of a discharging MOS transistor M2 are connected with an anode and an cathode of the second diode D2, respectively, the cathode of the second diode D2 is connected with a cathode of a first diode D1, an anode of the first diode D1 is connected with an anode of a high-current diode D3, the cathode of a first diode D1 is connected with a cathode of the high-current diode D3, a source and a drain of a charging MOS transistor M1 are connected with an anode and an cathode of the first diode D1, respectively, the anode of the high-current diode D3 is connected with an inverted input of a second comparator, the cathode of the high-current diode D3 is connected with an in-phase input of the second comparator, an output of the second comparator is connected with a gate of the charging MOS transistor M1 to form a cutting-off charge control circuit, the anode of the power supply is connected with an anode of a load, the cathode of the power supply is connected with a cathode of the load by the first diode D1 and second diode D2, wherein the D1 and D2 are parasitic reverse diodes of power MOS transistor.

While discharging, the second comparator is reversed, the charging MOS transistor M1 is shut off, so that discharging current entirely passes the high-current diode D3 to effectively prolong the service life the charging MOS transistor M1. At the same time, the bidirectional current automatic converter will automatically turn off the charge control circuit while discharging for reducing system power consumption to meet the lithium-ion battery with static low power consumption requirement.

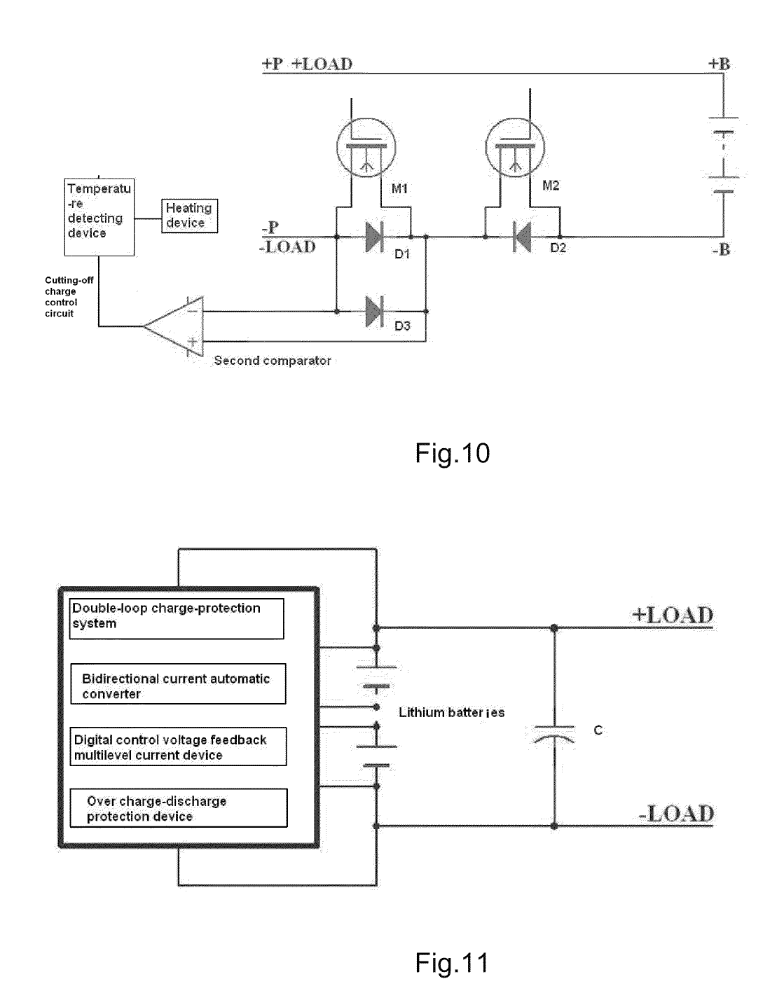

According to an alternative mode of the third preferred embodiment of the present invention, the bidirectional current automatic converter further comprises a temperature detecting device and a heating device connected with the temperature detecting device, wherein the output of the second comparator is connected with the heating device by the temperature detecting device to form the cutting-off charge control circuit, in such a manner that, while charging, the temperature detecting device and the heating device will be started. Once the temperature is increased to a value at which the power supply is fully charged, the heating process will be stopped, referring to FIG. 10.

FIG. 11 is a schematic view of a lithium-ion auto startup storage battery with a supercapacitor function according to a fourth preferred embodiment of the present invention, which comprises a power supply, composed of a plurality of lithium batteries connected with each other in series, a supercapacitor connected with the power supply in parallel, an over charge-discharge protection device connected with the power supply in parallel, a double-loop charge-protection system connected with the supercapacitor in parallel, a digital control voltage feedback multilevel current device connected with the supercapacitor in parallel, and a bidirectional current automatic converter connected with the supercapacitor in parallel.

In the fourth preferred embodiment of the present invention, the double-loop charge-protection system, digital control voltage feedback multilevel current device, and bidirectional current automatic converter are the same as illustrated in the first, second and third embodiment of the present invention, respectively.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lithium-ion auto startup storage battery with a supercapacitor function, comprising:
a power supply, composed of a plurality of lithium batteries connected with each other in series;
a supercapacitor connected with said power supply in parallel;
an over charge-discharge protection device connected with said power supply in parallel; and
a double-loop charge-protection system connected with said supercapacitor in parallel, comprising:
an inner loop circuit comprising a voltage clamping current shunting circuit module and a temperature comparing circuit connected with said voltage clamping current shunting circuit module,
wherein said voltage clamping current shunting circuit module comprises a voltage reference, a first comparator, a first resistance, a first switch, a second resistance, a second switch, and a current shunting control module, wherein said first resistance is connected with said first switch in series for forming a first voltage clamping shunt branch, said second resistance is connected with said second switch in series for forming a second voltage clamping shunt branch, wherein after connecting said first voltage clamping shunt branch with second voltage clamping shunt branch in parallel, one end of which is connected with an anode of said power supply, another end of which is connected with a cathode of said power supply by said current shunting control module, said anode of said power supply is connected with an in-phase input of said first comparator, said cathode of said power supply is connected with an inverted input of said first comparator, said output of said first comparator is connected with said current shunting control module, in such a manner that, said first voltage clamping shunt branch, current shunting control module, first comparator, voltage reference, power supply form a first voltage clamping shunt circuit, said second voltage clamping shunt branch, current shunting control module, first comparator, voltage reference, power supply form a second voltage clamping shunt circuit;
wherein said temperature comparing circuit of said inner loop circuit comprises a first hysteresis comparator, a NOT gate, and a second hysteresis comparator, wherein an in-phase input of said first hysteresis comparator inputs a temperature of said first voltage clamping shunt circuit, an inverted input of said first hysteresis comparator inputs a first or second temperature threshold, an output of said first hysteresis comparator is connected with an input of said NOT gate, an output of said NOT gate is connected with said first switch to control a closure of said first switch at high level, an in-phase input of said second hysteresis comparator inputs a temperature of said second voltage clamping shunt circuit, an inverted input of said second hysteresis comparator inputs said first or second temperature threshold, an output of said first hysteresis comparator is connected with said second switch to control said closure of said second switch at high level; and
an outer loop circuit, comprising a suspension charging module and AND gate, wherein said output of said first hysteresis comparator and said output of said second hysteresis comparator are two inputs of said AND gate respectively, an output of said AND gate is connected with said suspension charging module.

2. The lithium-ion auto startup storage battery with a supercapacitor function, as recited in claim 1, wherein said current shunting control module is a third switch.

3. The lithium-ion auto startup storage battery with a supercapacitor function, as recited in claim 1, wherein said current shunting control module is a MOS transistor.

4. The lithium-ion auto startup storage battery with a supercapacitor function, as recited in claim 1, wherein said voltage reference and first comparator define a unit comprising a first base divider resistor, a first adjustable resistor, a second base divider resistor, a second adjustable resistor, a capacitor, a third resistor, and a three-terminal regulator,
wherein said current shunting control module is a PNP transistor,
wherein said first base divider resistor is connected with said first adjustable resistor in series to form a third branch, said second base divider resistor is connected with said second adjustable resistor in series to form a fourth branch, an end of said third branch is connected with said anode of said power supply, an end of said fourth branch is connected with said cathode of said power supply, wherein after connecting another end of said third branch with that of said fourth branch, which is connected with a reference voltage setting terminal of said three-terminal regulator, an anode of said three-terminal regulator is connected with said cathode of said power supply by said fourth branch, an cathode of said three-terminal regulator is connected with said anode of said power supply by said third resistor, said reference voltage setting terminal and said cathode of said three-terminal regulator are connected with each other by said capacitor, said cathode of said three-terminal regulator is connected with a base of said PNP transistor, a collector of said PNP transistor is connected with said cathode of said power supply, an emitter of said PNP transistor is connected with said anode of said power supply.

5. The lithium-ion auto startup storage battery with a supercapacitor function, as recited in claim 1, wherein said voltage reference and first comparator define a unit comprising a first base divider resistor, a first adjustable resistor, a second base divider resistor, a second adjustable resistor, and a three-terminal regulator,
wherein said current shunting control module comprises a PNP transistor and a NPN transistor, wherein said first base divider resistor is connected with said first adjustable resistor in series to form a third branch, said second base divider resistor is connected with said second adjustable resistor in series to form a fourth branch, an end of said third branch is connected with said anode of said power supply, an end of said fourth branch is connected with said cathode of said power supply, wherein after connecting another end of said third branch with that of said fourth branch, which is connected with a reference voltage setting terminal of said three-terminal regulator, an anode of said three-terminal regulator is connected with said cathode of said power supply by said fourth branch, an cathode of said three-terminal regulator is connected with a base of said PNP transistor, an emitter of said PNP transistor is connected with said anode of said power supply, a collector of said PNP transistor is connected with a base of said NPN transistor, an emitter of said NPN transistor is connected with said cathode of said power supply, a collector of said NPN transistor is connected with said anode of said power supply.

6. The lithium-ion auto startup storage battery with a supercapacitor function, as recited in claim 1, further comprising a digital control voltage feedback multilevel current device connected with said supercapacitor in parallel, comprising:
a digital control module comprising a voltage detection unit, a balanced judging unit connected with said voltage detection unit, and a multi-level voltage supplementary charging controller connected with said balanced judging unit; and
a plurality of separately charging circuits, wherein each of said separately charging circuits comprises a diode and DC-DC module power supply, wherein each of said lithium batteries is matched with each of said separately charging circuits, a voltage of each of said lithium batteries is drawn out of a root thereof and feeds back to said digital control module, said diode is reverse-connected and then connected with said DC-DC module power supply.

7. The lithium-ion auto startup storage battery with a supercapacitor function, as recited in claim 2, further comprising a digital control voltage feedback multilevel current device connected with said supercapacitor in parallel, comprising:
a digital control module comprising a voltage detection unit, a balanced judging unit connected with said voltage detection unit, and a multi-level voltage supplementary charging controller connected with said balanced judging unit; and
a plurality of separately charging circuits, wherein each of said separately charging circuits comprises a diode and DC-DC module power supply, wherein each of said lithium batteries is matched with each of said separately charging circuits, a voltage of each of said lithium batteries is drawn out of a root thereof and feeds back to said digital control module, said diode is reverse-connected and then connected with said DC-DC module power supply.

8. The lithium-ion auto startup storage battery with a supercapacitor function, as recited in claim 4, further comprising a digital control voltage feedback multilevel current device connected with said supercapacitor in parallel, comprising:
a digital control module comprising a voltage detection unit, a balanced judging unit connected with said voltage detection unit, and a multi-level voltage supplementary charging controller connected with said balanced judging unit; and
a plurality of separately charging circuits, wherein each of said separately charging circuits comprises a diode and DC-DC module power supply, wherein each of said lithium batteries is matched with each of said separately charging circuits, a voltage of each of said lithium batteries is drawn out of a root thereof and feeds back to said digital control module, said diode is reverse-connected and then connected with said DC-DC module power supply.

9. The lithium-ion auto startup storage battery with a supercapacitor function, as recited in claim 5, further comprising a digital control voltage feedback multilevel current device connected with said supercapacitor in parallel, comprising:
a digital control module comprising a voltage detection unit, a balanced judging unit connected with said voltage detection unit, and a multi-level voltage supplementary charging controller connected with said balanced judging unit; and
a plurality of separately charging circuits, wherein each of said separately charging circuits comprises a diode and DC-DC module power supply, wherein each of said lithium batteries is matched with each of said separately charging circuits, a voltage of each of said lithium batteries is drawn out of a root thereof and feeds back to said digital control module, said diode is reverse-connected and then connected with said DC-DC module power supply.

10. The lithium-ion auto startup storage battery with a supercapacitor function, as recited in claim 6, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

11. The lithium-ion auto startup storage battery with a supercapacitor function, as recited in claim 7, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

12. The lithium-ion auto startup storage battery with a supercapacitor function, as recited in claim 8, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

13. The lithium-ion auto startup storage battery with a supercapacitor function, as recited in claim 9, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

14. The lithium-ion auto startup storage battery with a supercapacitor function, as recited in claim 1, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

15. The lithium-ion auto startup storage battery with a supercapacitor function, as recited in claim 2, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

16. The lithium-ion auto startup storage battery with a supercapacitor function, as recited in claim 14, wherein said bidirectional current automatic converter further comprises a temperature detecting device and a heating device connected with said temperature detecting device, wherein said output of said second comparator is connected with said heating device by said temperature detecting device.

17. A lithium-ion auto startup storage battery with a supercapacitor function, comprising:
a power supply, composed of a plurality of lithium batteries connected with each other in series;
a supercapacitor connected with said power supply in parallel;
an over charge-discharge protection device connected with said power supply in parallel; and
a digital control voltage feedback multilevel current device connected with said supercapacitor in parallel, comprising:
a digital control module comprising a voltage detection unit, a balanced judging unit connected with said voltage detection unit, and a multi-level voltage supplementary charging controller connected with said balanced judging unit; and
a plurality of separately charging circuits, wherein each of said separately charging circuits comprises a diode and DC-DC module power supply, wherein each of said lithium batteries is matched with each of said separately charging circuits, a voltage of each of said lithium batteries is drawn out of a root thereof and feeds back to said digital control module, said diode is reverse-connected and then connected with said DC-DC module power supply.

18. The lithium-ion auto startup storage battery with a supercapacitor function, as recited in claim 17, further comprising a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

19. A lithium-ion auto startup storage battery with a supercapacitor function, comprising:
a power supply, composed of a plurality of lithium batteries connected with each other in series;
a supercapacitor connected with said power supply in parallel;
an over charge-discharge protection device connected with said power supply in parallel; and
a bidirectional current automatic converter connected with said supercapacitor in parallel, comprising:
a charging MOS transistor, a first diode, a discharging MOS transistor, a second diode, a high-current diode, a second comparator, wherein said cathode of said power supply is connected with an anode of said second diode, a source and a drain of said discharging MOS transistor are connected with an anode and an cathode of said second diode respectively, said cathode of said second diode is connected with a cathode of said first diode, an anode of said first diode is connected with an anode of said high-current diode, said cathode of said first diode is connected with a cathode of said high-current diode, a source and a drain of said charging MOS transistor are connected with said anode and said cathode of said first diode respectively, said anode of said high-current diode is connected with an inverted input of a second comparator, said cathode of said high-current diode is connected with an in-phase input of said second comparator, an output of said second comparator is connected with a gate of said charging MOS transistor, said anode of said power supply is connected with an anode of a load, said cathode of said power supply is connected with a cathode of said load by said first diode and second diode, wherein said first diode and said second diode are parasitic reverse diodes of power MOS transistor.

20. The lithium-ion auto startup storage battery with a supercapacitor function, as recited in claim 19, wherein said bidirectional current automatic converter further comprises a temperature detecting device and a heating device connected with said temperature detecting device, wherein said output of said second comparator is connected with said heating device by said temperature detecting device.
